(19) United States
(12) Patent Application Publication
(10) Pub. No.: US 2003/0217278 A1
(43) Pub. Date: Nov. 20, 2003

(54) Computer, hard disk device, disk device sharing system composed of the plural said computers and shared hard disk device, and sharing method applied to the said sharing system

(76) Inventors: Shinji Kimura, Sagamihara (JP); Teiji Karasaki, Isehara (JP); Masahide Sato, Kawasaki (JP); Satoshi Oshima, Tachikawa (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/352,108

(22) Filed: Jan. 28, 2003

(30) Foreign Application Priority Data
May 20, 2002 (JP) 2002-144942

(51) Int. Cl. H04L 9/00

(52) U.S. Cl. 713/189; 713/150

(57) ABSTRACT

There is provided a disk device sharing system which, in an environment in which plural computers and a shared hard disk device are interconnected via a network, can realize safe data communication between the computers and the hard disk device and can reduce the operation cost needed for maintenance of the computers.

One computer is equipped with two OSs. One is a first OS executing an application program. The other is a second OS performing communication processing with a shared hard disk device. Access from the application program to the shared hard disk device must be done via the second OS. The application program and the first OS are controlled so as not to directly access the hard disk device.

### BACKGROUND OF THE INVENTION

The present invention relates to a disk device sharing system in which plural computers share a hard disk device. More specifically, the present invention relates to a sharing method applied to the sharing system.

Computers can be classified by forms used. A computer such as a personal computer a user uses in an application program such as document processing is called a client computer. A computer such as a Web server and a mail server executing an application program for providing a service to plural users is called a server computer.

Such client computer and server computer have the same basic configuration and are equipped with a high-performance CPU, a large size memory, a large-capacity hard disk device, and a high-speed graphical unit. An operating system (OS), an application program and user data are stored in a hard disk device as a storage device.

There is a computer form called a network computer. This is not provided with a hard disk device storing an OS and an application program in each of client computers, executes the application program on a server computer, and is provided with a function of only its display. The computer is less expensive and stripped-down.

As a method for sharing a hard disk device by plural computers, there is known an iSCSI (Internet Small Computer Systems Interface) protocol using an SCSI protocol for accessing a hard disk device as a communication protocol on a network such as Ethernet (trademark).

When a computer has a pre-boot/remote boot function, an OS and an application program can be loaded from a server computer. It is combined with the sharing of a hard disk device using the iSCSI protocol to realize a computer which need not be provided with a hard disk device. Such computer is called a diskless computer.

The above diskless computer can simplify operations including install, version upgrade and backup for storing the OS, application program and user data in the hard disk device shared by the network.

In the form connecting the computer and the storage device using the network such as Ethernet (trademark), data on the network can be sniffed and is not safe. Sniffing means data falsification by hackers.

In the form connecting plural diskless computers and a shared hard disk device by a network, when the manager authorization of one diskless computer is stolen, the safety of data in the computers and the hard disk device on the same network is lost.

### SUMMARY OF THE INVENTION

An object of the present invention is to provide a disk device sharing system which, in an environment in which plural computers and a shared hard disk device are interconnected via a network, can realize safe data communication and can reduce the operation cost needed for maintenance of the computers.

To solve the above problems and achieve the foregoing object, in the present invention, one computer is equipped with two OSs. One is a first OS executing an application program. The other is a second OS performing communication processing with a shared hard disk device. According to the present invention, when the manager authorization of the first OS executing the application program is stolen by an invalid program and the manager authorization of the second OS is not stolen, the shared hard disk device cannot be accessed.

According to the present invention, communication data between the second OS and the shared hard disk device is encrypted so as to prevent data from being sniffed from other computers. When the OSs of the computers are delivered from the shared hard disk device using a pre-boot/remote boot function, key data needed for encrypting the communication data is delivered together with the OS remote-booted. The key data need not be stored in the computers. The key data can be prevented from being stolen.

The key data delivered is stored in a memory area managed by the second OS and cannot be accessed from the first OS. The safety can be increased.

### BRIEF DESCRIPTION OF THE DRAWINGS

FIG. 1 is a system configuration diagram showing the configuration of a computer environment using a disk device sharing system according to an embodiment of the present invention;

FIG. 2 is a configuration diagram of software operated on the computers shown in FIG. 1;

FIG. 3 is a configuration diagram of software operated on the hard disk device shown in FIG. 1;

FIG. 4 is a diagram showing data structures of a user information table;

FIG. 5 is a diagram showing data structures of a computer information table;

FIG. 6 is a diagram showing data structures of a map information table;

FIG. 7 is a diagram showing data structures of a key data table; and

FIG. 8(a) is a flowchart showing a boot processing procedure of the computer in the system configuration shown in FIG. 1 of the present invention, and

FIG. 8(b) is a diagram showing a detailed flow of program transfer processing in the flowchart shown in FIG. 8(a).

### DESCRIPTION OF THE PREFERRED EMBODIMENT

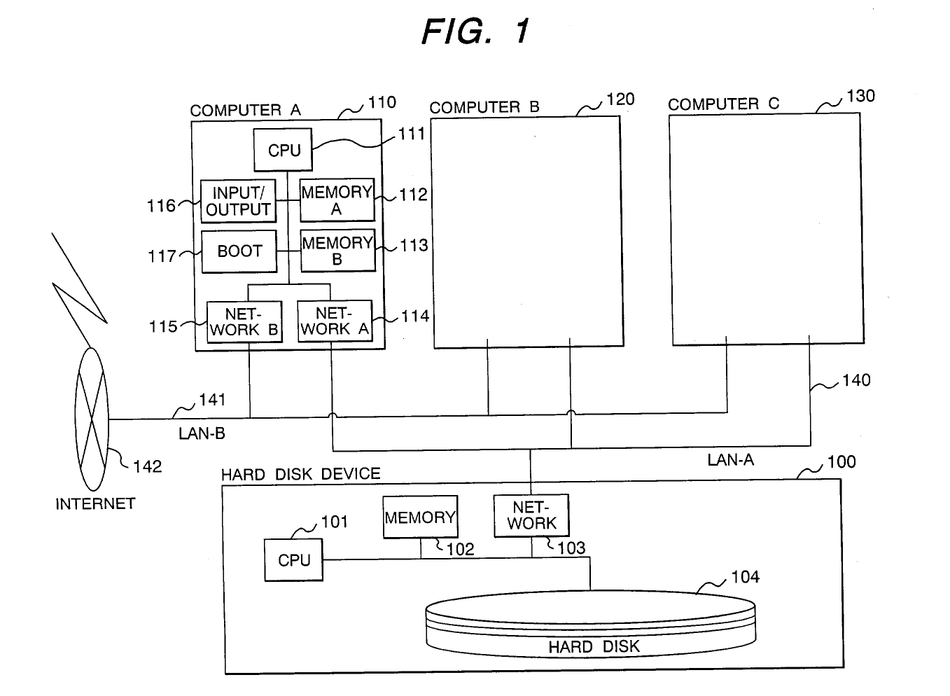

A preferred embodiment of the present invention will be described. The same numerals of the drawings showing the embodiment denote the same thing or an equivalent. The embodiment of the present invention will be described below using the drawings. FIG. 1 is a diagram showing the configuration of a computer environment using a disk device sharing system according to an embodiment of the present invention.

A hard disk device 100 is a shared hard disk device for storing the OSs, application program and user data of computers A110, B120 and C130. The hard disk device has a CPU 101, a memory 102, a network device 103 and a hard disk device 104. The hard disk device 104 stores the OSs, application program and user data of each user.

The computers A110, B120 and C130 are computers used by users A, B and C. Each of the computers has a CPU 111, a memory A112, a memory B113, a network device A114, a network device B115, an input/output device 116 and a boot control circuit 117. The network device A114 incorporated in each of the computers is connected via a LAN-A140 to the hard disk device 100. The network device B115 is connected via a LAN-B141 to an internet 142. The input/output device 116 has a keyboard and a display device.

The disk device sharing system shown in FIG. 1 according to the embodiment of the present invention can be provided as a disk device sharing system having features of the following items (a) to (f).

(a) A disk device sharing system having plural computers executing an application program and a hard disk device shared by the plural computers in which the plural computers and the hard disk device are interconnected via a network, wherein

the plural computers have a first operating system executing the application program and a second operating system performing communication processing between the computers and the hard disk device, the first operating system and the second operating system being executed to be independent from each other.

(b) The disk device sharing system according to the (a), wherein the first operating system is a user processing OS controlling the application program executed by a user in the computer, the second operating system is a communication processing OS controlling communication processing between the computers and the hard disk device, and the plural computers are not provided with an incorporated disk.

(c) The disk device sharing system according to the (b), wherein the hard disk device has key-generation data and encrypts communication data between the plural computers and the hard disk device.

(d) The disk device sharing system according to the (c), wherein the plural computers program boot the first operating system, the second operating system and the application program from the hard disk device via the network.

(e) The disk device sharing system according to the (c), wherein the plural computers program boot the first operating system and the second operating system from the hard disk device via the network and load the application program as data from the hard disk device.

(f) The disk device sharing system according to the (e), wherein the hard disk device generates key data based on the key-generation data to encrypt communication data between the plural computers and the hard disk device and delivers the key-generation data or the key data to the plural computers at the program boot.

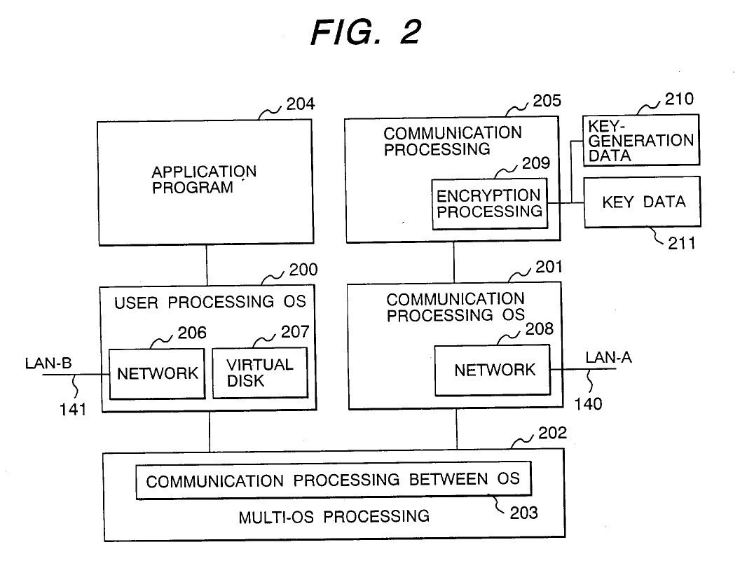

FIG. 2 shows the configuration of software operated on the computers A110, B120 and C130 of FIG. 1 according to the embodiment of the present invention.

In each of the computers, a user processing OS 200 executing an application program 204 used by the user and a communication processing OS 201 processing communication with the hard disk device 100 are executed independently. Independent execution means that the two OSs divide and use the memories and the input/output device as a resource of the computers 110, 120 and 130 so that the mutual execution will not affect others. Processing for executing the multiple OSs is done by multi-OS processing 202. A technique independently executing the multiple OSs on one computer is disclosed in Japanese Patent Application Laid-Open No. Hei 11-149385 (hereinafter, referred to as document 1). In the document 1, the user processing OS 200 and the communication processing OS 201 can be executed independently, and when the user processing OS 200 is stopped due to failure, the communication processing OS 201 can be operated continuously.

The user processing OS 200 has network processing 206 for connection via the LAN-B141 to the Internet and virtual disk processing 207 for converting a typically transmitted control command to a communication protocol to the disk device in access from the application program 204 to the disk device. The virtual disk processing 207 uses OS communication processing 203 provided by the multi-OS processing 202 and sends communication data to communication processing 205 executed by the other OS processing 201. The communication processing 205 encrypts the communication data in encryption processing 209 when necessary. Network processing 208 of the communication processing OS 201 performs communication processing with the hard disk device 100 via the LAN-A140. When encrypting the communication data of the computers 110, 120 and 130 and the hard disk device 100, communication is performed by the communication data encrypted using key data 211 obtained from key-generation data 210 stored in the memory. A112 (FIG. 1). The communication data encryption follows a public-key cryptosystem. The communication processing OS 201, the multi-OS processing 203 and the key-generation data 210 are stored in the memory A112. The user processing OS 200 is stored in the memory B113. The processing software and data are loaded from the hard disk 100 by network boot via the LAN-A140 using the network device A114 by a pre-boot/remote boot function stored in the boot control circuit 117 at power on of the computers 110, 120 and 130.

The computers A110, B120 and C130 of FIG. 1 operated based on the configuration of the software shown in FIG. 2 of the present invention can be provided as a computer having features of the following items (I) to (III).

(I) A computer having a first OS and a second OS, wherein the first OS and the second OS are executed to be independent from each other, the computer has application software used by a user and a communication processing part, data obtained after the user executes the application software by control of the first OS is encrypted by control of the second OS in an encryption processing unit of the communication processing part, and the encrypted data is transmitted via a network part controlled by the second OS to the hard disk device connected to an external interface.

(II) The computer according to the (I), wherein the second OS controls the communication processing part, and the encryption processing unit generates key data based on key-generation data delivered from the hard disk device to perform the encryption of the data.

(III) The computer according to the (II), wherein the first OS is a user processing OS controlling the application software, and the second OS is a communication processing OS performing communication of the encrypted data with the hard disk device via the network part.

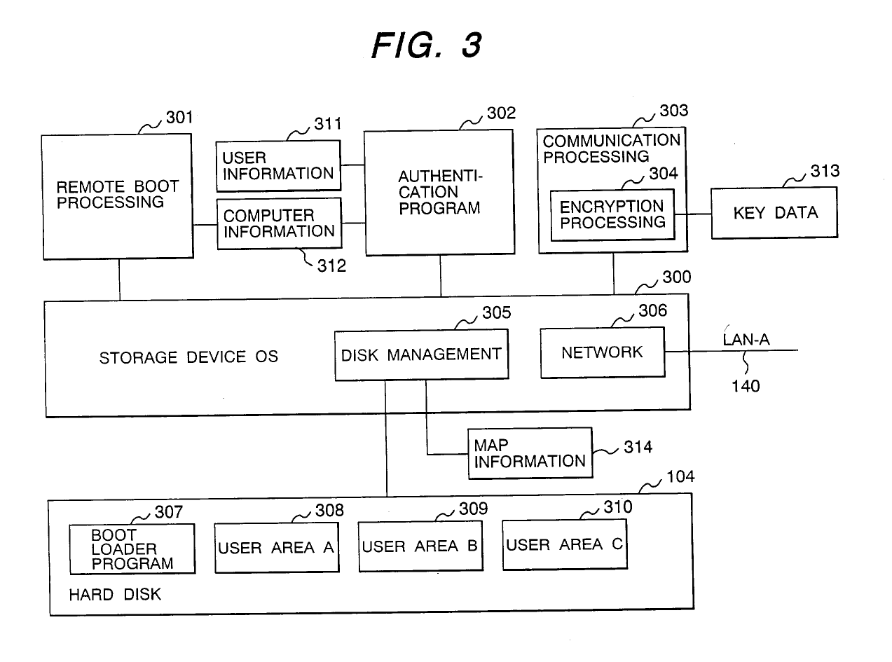

FIG. 3 shows the configuration of software operated on the hard disk device 100 according to the embodiment of the present invention. A storage device OS 300 is operated on the hard disk device 100. On the storage device OS 300 are operated remote boot processing 301 processing a pre-boot/remote boot request from the computers, an authentication program 302 authenticating the user using each of the computers, and communication processing 303 performing communication processing with the computers. The storage device OS 300 has disk management processing 305 for controlling a storage device storing a program and data necessary for execution of the computers, and network processing 306 for performing communication with the computers via the LAN-A140. The hard disk device 104 is divided into some areas. The hard disk device 104 has a boot loader program 307 for network booting the computers in the areas, and areas for storing the OSs, application program and user data for each of the users. A user area A 308, a user area B 309, and a user area C 310 are included in the areas.

Data needed for the software processing are stored in the hard disk device 104. The hard disk device 100 has user information 311, computer information 312, key data 313 and map information 314. The user information 311 is information managing the user having authentication of access to the program/data stored in the hard disk device 100. The computer information 312 is information managing the computer having access authentication. The key data 313 stores key data needed when communication data between the computers and the hard disk device 100 is encrypted by encryption processing 304. The map information 314 stores the area correspondence relation between the user/computer having access authentication and the hard disk device 104.

The hard disk device 100 of FIG. 1 operated based on the configuration of the software shown in FIG. 3 of the present invention can be provided as a hard disk device having features of the following items (i) to (vii).

(i) A hard disk device having a CPU, a memory, a hard disk unit and a network part, wherein the CPU includes a boot processing part, an authentication program unit, a communication processing part and a disk management part controlling the hard disk unit; the communication processing part has an encryption processing unit and key-generation data; the authentication program unit holds hardware information of each of plural computers connected via the network part and user information managing the computer; the hard disk unit has plural areas in which the hardware information for each of the plural computers is stored; and the encryption processing unit processes a boot request transmitted from the computer in the boot processing part, generates key data based on the key-generation data, and adds the key-generation data or key data to the hardware information to deliver it to the computer transmitting the boot request.

(ii) The hard disk device according to the (i), wherein the hardware information includes a user processing OS and a communication processing OS stored in each of the computers and an application program used by a user, and the user information is authentication information for identifying the user.

(iii) The hard disk device according to the (ii), wherein the authentication information is information of the name of a user using the computer, the password of the user, and a data storing disk used by the user.

(iv) The hard disk device according to the (i), wherein the key data is generated by a key data part of the encryption processing unit, and the key data part holds inherent data and encryption information for identifying the computer.

(v) The hard disk device according to the (iv), wherein the inherent data and encryption information is information including a network address of the computer, the key-generation data, the key data, and generation time of the key data.

(vi) The hard disk device according to the (i), wherein according to control of the disk management part, the encrypted communication data transmitted from the computer is processed by the communication processing part so as to store the encrypted communication data in any one of the plural areas of the hard disk unit.

(vii) The hard disk device according to the (vi), wherein according to control of the disk management part, the encrypted communication data transmitted from the computer is returned to unencrypted original data using the key data of the encryption processing unit so as to store the original data in any one of the plural areas.

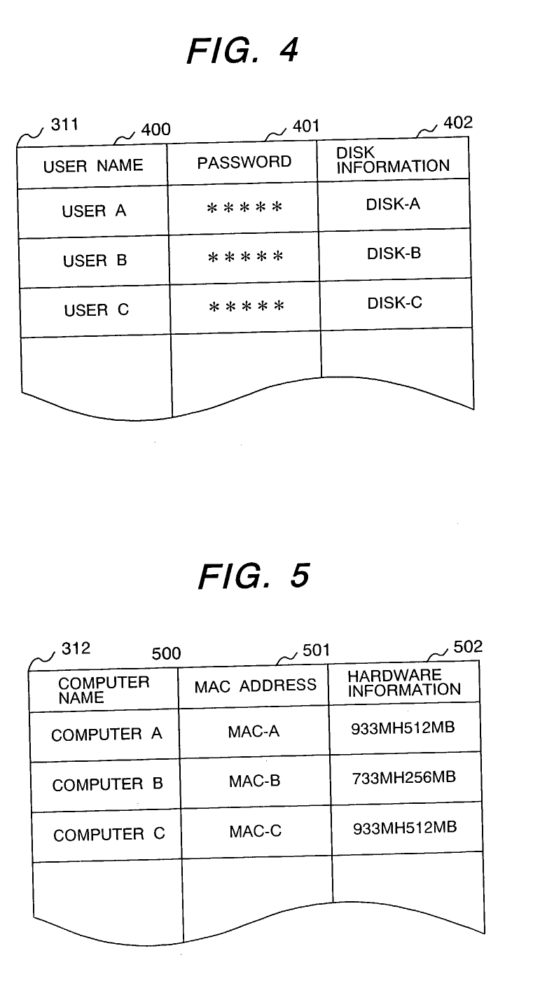

FIGS. 4 to 7 are tables showing data structures. The tables are used by software 300, 301, 302 and 303 operated on the hard disk 100 stored in the hard disk device 104. The software 300, 301, 302 and 303 correspond to the storage device OS 300, the remote boot processing 301, the authentication program 302, and the communication processing 303, respectively.

FIG. 4 is a table structure showing the details of the user information 311. The user information 311 has a user name 400 storing the name of a user, a password 401 for authenticating the user, and data disk information 402 showing the area of the hard disk device 104 to which the user is allocated.

FIG. 5 is a table structure showing the details of the computer information 312. The computer information 312 has a computer name 500 storing the name for identifying a computer, an MAC address 501 as inherent hardware information for each of the network devices A114 of the computers, and hardware information 502 obtained from the configuration information of each of the computers. The hardware information 502 uses a value obtained by calculation from the clock performance of the CPU 111 and the total value of the on-board memory sizes of the memories A112 and B113 of each of the computers. The MAC corresponds to Media Access Control.

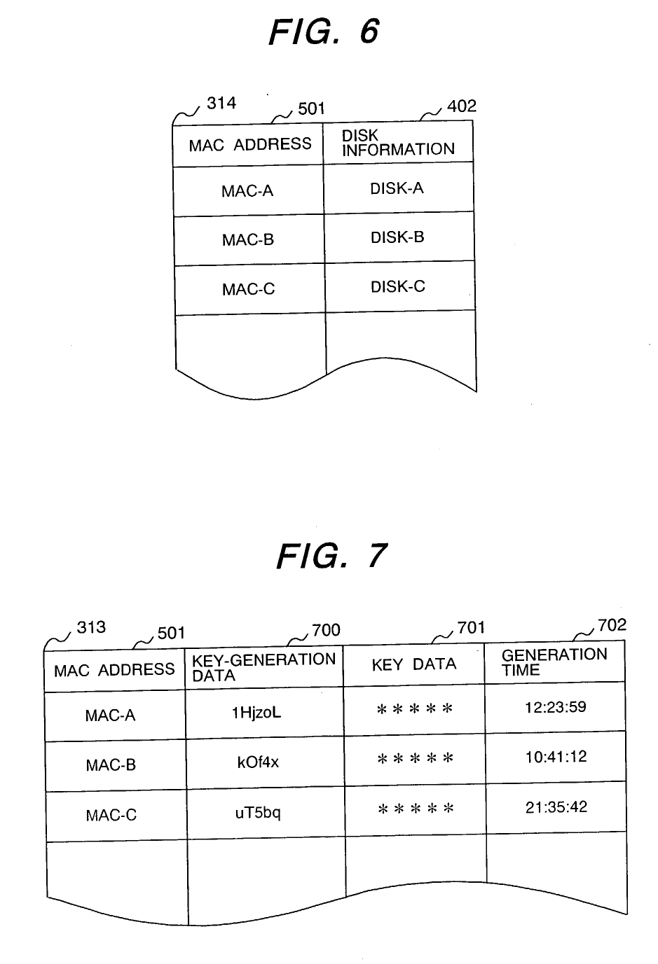

FIG. 6 is a table structure showing the details of the map information 314. The map information 314 is a table storing the correspondence of the computer used by the user with the hard disk area needed by the computer. The map information 314 stores the disk information 402 obtained from the user information 311 and the MAC address 501 obtained from the computer information 312.

FIG. 7 is a table structure showing the details of the key data 313. The key data 313 stores the MAC address 501 obtained from the computer information 312 to identify the computers and manages the key data for each of the MAC addresses 501. The table of the key data 313 stores key-generation data 700 for generating key data for encryption. It stores key data 701 generated from the key-generation data 700 and used for encrypting communication data. It stores generation time 702 generating the key data 701. A value different for each of the computers is set as the key-generation data 700. The generated key data manages the generation time. The key data 701 is generated from the key-generation data 700 for each fixed time. The key data used for encryption is changed to increase the safety of the communication data.

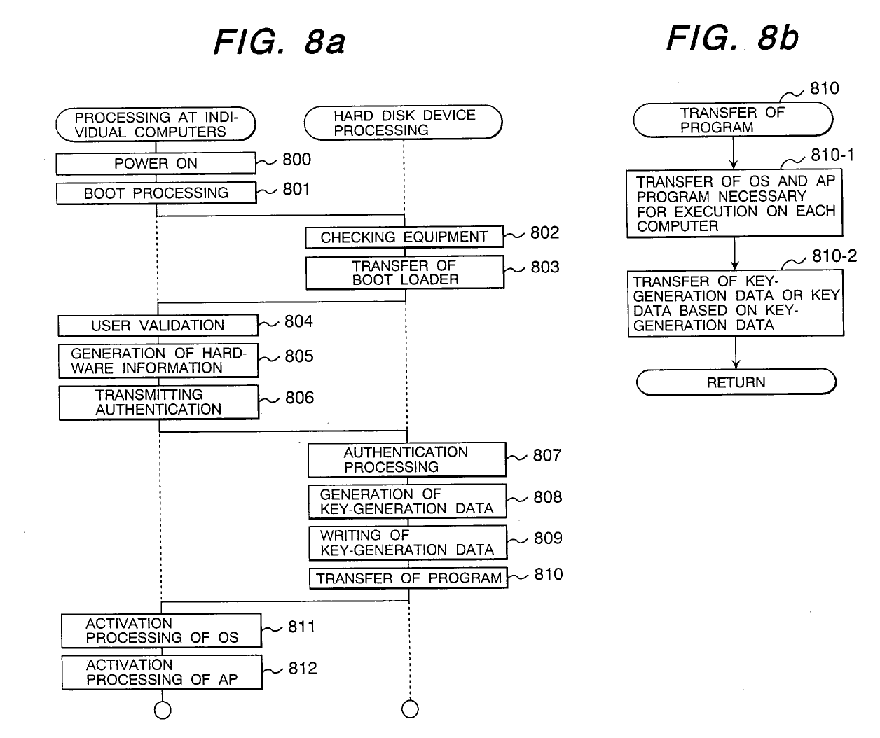

FIGS. 8(a) and (b) are flowcharts showing a program activation procedure of the individual computers 110, 120 and 130 and the hard disk device 100 shown in FIG. 1.

In the program activation procedure, at power on of the computers 110, 120 and 130 (step 800), the boot control circuit 117 is activated and the network device A114 is used to request the pre-boot/remote boot to the network of the LAN-A140 (step 801).

The pre-boot/remote boot request on the LAN-A140 is accepted by the remote boot processing 301 (FIG. 3) in the hard disk device 100. The remote boot processing 301 refers to the computer information 312 to compare the computer name 500 (FIG. 5) of the computer requesting the pre-boot/remote boot with the MAC address 501 (step 802). In the case of the computer stored in the table, the boot loader program 307 is transmitted to the requesting computer (step 803).

The requesting computer executes the boot loader program 307 transmitted from the hard disk device 100 to validate the user name and the password of the user by the input/output device 116 (step 804). The computer calculates a value (the hardware information 502) combining the clock performance of the CPU 111 of the computer used by the user with the total value of the on-board memory sizes of the memories A112 and B113 (step 805). The computer transmits, as authentication, the user name, password and hardware information to the hard disk device 100 (step 806).

The authentication program 302 in the hard disk device 100 compares the transmitted authentication, the user 400 and the password 401 of the user information 311 (FIG. 4), and the computer name 500, the MAC address 501 and the hardware information 502 of the computer information 312 (FIG. 5). In the case of the user/computer having use authentication, the MAC address 501 and the disk information 402 are stored in the map information 314 (FIG. 6) (step 807). The key-generation data 700 for encrypting the communication data with the requesting computer is generated to store the corresponding MAC address and the generated key-generation data 700 in the table (FIG. 7) of the key data 313 (step 808).

The generated key-generation data 700 performs writing to the storing area of the key-generation data 210 (FIG. 2) in the hard disk area of the user (step 809). The user processing OS 200, the communication processing OS 201, and the multi-OS processing 202 in the hard disk area 104 into which the key-generation data 210 is written are transmitted to the requesting computer (step 810).

The requesting computer activates the transmitted OSs 200, 201 and 202 (step 811) to perform activation processing of the communication processing operated on the communication processing OS 201 and the application program operated on the user processing OS 200 in that order (step 812).

The activation of the program on the computer is thus completed. As described previously, an access request of the application program to the disk is performed. The access request is sent to the hard disk device 100 by the virtual disk processing 207 and the communication processing 205 shown in FIG. 2 to realize access from the computers to the hard disk.

When encrypting the communication data between the computers 110, 120 and 130 and the hard disk device 100, the key-generation data 210 and 700 needed for encrypting the communication data are generated for each of the computers in the hard disk device in the step 808. The key data is generated from the key-generation data. In the step 810, as shown in the flowchart of FIG. 8(b), in the steps 810-1 and 810-2, the key-generation data or the key data is transmitted to the computers at network boot. The communication data used in the access of the application program to the disk after the step 812 shown in FIG. 8(a) can be encrypted.

In the disk device sharing system of FIG. 1 in which the program is activated according to the flowchart showing the program activation procedure shown in FIG. 8 of the present invention, the method in which the computers 110, 120 and 130 share the hard disk device 100 can be provided as a disk device sharing method having features of the following items (1) to (4).

(1) A disk device sharing method in a computer system having plural computers and a hard disk device shared by the plural computers in which the plural computers and the hard disk device are interconnected via a network, including:

a step in which the computer system performs boot processing;

a step in which after the boot processing, the computer generates authentication to transmit it to the hard disk device after a user inputs an authentication ID;

a step in which the hard disk device performs authentication processing of the authentication and an encryption processing part of the hard disk device generates key data to the plural computers; and

a step in which the key data is delivered to the computer together with an operating system necessary for execution of the computer and application software used by the user.

(2) The disk device sharing method according to the (1), wherein the hard disk device has key-generation data and a key data part, and in the generation step, the key data is generated based on the key-generation data, and the key data part stores the key data needed when communication data between the plural computers and the hard disk device are encrypted by the encryption processing part.

(3) The disk device sharing method according to the (2), wherein the operating system includes a user processing OS and a communication processing OS, and in the delivering step, the key-generation data or key data is transmitted to the computer together with the operating system and application software.

(4) The disk device sharing method according to the (1), further including a step in which using the key data, the computer encrypts data obtained after executing the application software used by the user, transferring it via the network to the hard disk device.

According to the above-described embodiment, the computer is not provided with a hard disk device for storing a program and data and can store the program and data in the hard disk device on the network. Install and version upgrade of the application program and OS and backup of data can be managed in a unified way. The operation managing cost can be reduced to realize the computer system having a low TCO.

According to this embodiment, one computer is equipped with two OSs to realize function sharing the OS executing the application program and the OS executing communication processing with the shared hard disk device. This can separate an external network such as an internet from an internal network for realizing access to the hard disk device. When the manager authorization of the OS executing the application program is stolen from an invalid program from the external network, the invalid program cannot be included into the internal program since the OS executing independent communication processing is provided. The safety of the shared hard disk device can be increased.

According to this embodiment, when encrypting communication data between the computers and the hard disk device, data for generating key data needed for encryption is delivered when the computer is network booted. The data need not be stored in the computer and the data for encryption cannot be stolen by hardware analysis of the computer. The key-generation data delivered at the network boot is stored in the other OS side executing communication processing independent from one OS executing the application program. When the manager authorization of the OS executing the application program is stolen by the invalid program via the external network, the key-generation data can be protected.

As described above, according to the present invention, in an environment in which plural computers and a shared hard disk device are interconnected via a network, it is possible to provide a disk device sharing system which can realize safe data communication and reduce the operation cost needed for maintenance of the computer.

What is claimed is:

1. A disk device sharing system having plural computers executing an application program and a hard disk device shared by the plural said computers in which the plural said computers and the said hard disk device are interconnected via a network, wherein
the plural said computers have a first operating system executing the said application program and a second operating system performing communication processing between the said computers and the said hard disk device, the said first operating system and the said second operating system being executed to be independent from each other.

2. The disk device sharing system according to claim 1, wherein the said first operating system is a user processing OS controlling the said application program executed by a user in the said computer, the said second operating system is a communication processing OS controlling communication processing between the said computers and the said hard disk device, and the plural said computers are not provided with an incorporated disk.

3. The disk device sharing system according to claim 2, wherein the said hard disk device has key-generation data and encrypts communication data between the plural said computers and the said hard disk device.

4. The disk device sharing system according to claim 3, wherein the plural said computers program boot the said first operating system, the said second operating system and the said application program from the said hard disk device via the said network.

5. The disk device sharing system according to claim 3, wherein the plural said computers program boot the said first operating system and the said second operating system from the said hard disk device via the said network and load the said application program as data from the said hard disk device.

6. The disk device sharing system according to claim 5, wherein the said hard disk device generates key data based on the said key-generation data to encrypt communication data between the plural said computers and the said hard disk device and delivers the said key-generation data or the said key data to the plural said computers at the said program boot.

7. A computer having a first OS and a second OS, wherein the said first OS and the said second OS are executed to be independent from each other, the said computer has application software used by a user and a communication processing part, data obtained after the said user executes the said application software by control of the said first OS is encrypted by control of the said second OS in an encryption processing unit of the said communication processing part, and the said encrypted data is transmitted via a network part controlled by the said second OS to the hard disk device connected to an external interface.

8. The computer according to claim 7, wherein the said second OS controls the said communication processing part, and the said encryption processing unit generates key data based on key-generation data delivered from the said hard disk device to perform the said encryption of the said data.

9. The computer according to claim 8, wherein the said first OS is a user processing OS controlling the said application software, and the said second OS is a communication processing OS performing communication of the said encrypted data with the said hard disk device via the said network part.

10. A hard disk device having a CPU, a memory, a hard disk unit and a network part, wherein
the said CPU includes a boot processing part, an authentication program unit, a communication processing part and a disk management part controlling the said hard disk unit;
the said communication processing part has an encryption processing unit and key-generation data;
the said authentication program unit holds hardware information of each of plural computers connected via the said network part and user information managing said computer;
the said hard disk unit has plural areas in which the said hardware information for each of the plural said computers is stored; and
the said encryption processing unit processes a boot request transmitted from the said computer in the said boot processing part, generates key data based on the said key-generation data, and adds the said key-generation data or key data to the said hardware information to deliver it to the said computer transmitting the said boot request.

11. The hard disk device according to claim 10, wherein the said hardware information includes a user processing OS and a communication processing OS stored in each of the said computers and an application program used by a user, and the said user information is authentication information for identifying the user.

12. The hard disk device according to claim 11, wherein the said authentication information is information of the name of a user using the said computer, the password of the said user, and a data storing disk used by the said user.

13. The hard disk device according to claim 10, wherein the said key data is generated by a key data part of the said encryption processing unit, and the said key data part holds inherent data and encryption information for identifying the computer.

14. The hard disk device according to claim 13, wherein the said inherent data and encryption information is information including a network address of the said computer, the said key-generation data, the said key data, and generation time of the said key data.

15. The hard disk device according to claim 10, wherein according to control of the said disk management part, the said encrypted communication data transmitted from the said computer is processed by the said communication processing part so as to store the said encrypted communication data in any one of the plural said areas of the said hard disk unit.

16. The hard disk device according to claim 15, wherein according to control of the said disk management part, the said encrypted communication data transmitted from the said computer is returned to unencrypted original data using the said key data of the said encryption processing unit so as to store the said original data in any one of the plural said areas.

17. A disk device sharing method in a computer system having plural computers and a hard disk device shared by the plural said computers in which the plural said computers and the said hard disk device are interconnected via a network, comprising:
a step in which the said computer system performs boot processing;
a step in which after the said boot processing, the said computer generates authentication to transmit it to the said hard disk device after a user inputs an authentication ID;
a step in which the said hard disk device performs authentication processing of the said authentication and an encryption processing part of the said hard disk device generates key data to the plural said computers; and
a step in which the said key data is delivered to the said computer together with an operating system necessary for execution of the said computer and application software used by the said user.

18. The disk device sharing method according to claim 17, wherein the said hard disk device has key-generation data and a key data part, and in the said generation step, the said key data is generated based on the said key-generation data, and the said key data part stores the said key data needed when communication data between the plural said computers and the said hard disk device are encrypted by the said encryption processing part.

19. The disk device sharing method according to claim 18, wherein the said operating system includes a user processing OS and a communication processing OS, and in the said delivering step, the said key-generation data or key data is transmitted to the said computer together with the said operating system and application software.

20. The disk device sharing method according to claim 17, further comprising a step in which using the said key data, the said computer encrypts data obtained after executing the application software used by the said user, transferring it via the said network to the said hard disk device.
